(19) United States
(12) Patent Application Publication
(10) Pub. No.: US 2018/0274170 A1
(43) Pub. Date: Sep. 27, 2018

(54) METHOD AND DEVICE FOR PRODUCING A BRAID AND A BRAID

(71) Applicant: LEONI KABEL GMBH, NUERNBERG (DE)

(72) Inventors: KLAUS FALKENBERG, NUERNBERG (DE); ERWIN KOEPPENDOERFER, SCHWABACH (DE)

(21) Appl. No.: 15/928,322

(22) Filed: Mar. 22, 2018

(30) Foreign Application Priority Data
Mar. 22, 2017 (DE) 102017204860.3

(51) Int. Cl. D07B 1/06; D07B 7/02; H01B 13/26

(52) U.S. Cl. CPC D07B 1/0673; D07B 7/02; D07B 2501/2076; D07B 2201/1096; D07B 2205/3021; H01B 13/2606

(57) ABSTRACT

In a method for producing a braid that extends in a longitudinal direction, multiple individual strands are interwoven with one another. For this purpose, first and second spools are moved relative to one another, the individual strands being wound onto the spools. The first spools having first individual strands are guided on a path that circulates about the longitudinal axis with the result that the first individual strands are arranged in a helical manner at least in sections about the longitudinal axis. The second spools having second individual strands are arranged with respect to the direction of rotation at fixed angular positions with the result that the second individual strands are incorporated into the braid in a manner in which they extend parallel to the longitudinal direction.

### CROSS-REFERENCE TO RELATED APPLICATION

This application claims the priority, under 35 U.S.C. § 119, of German application DE 10 2017 204 860.3, filed Mar. 22, 2017; the prior application is herewith incorporated by reference in its entirety.

### BACKGROUND OF THE INVENTION

### Field of the Invention

The invention relates to a method and to a device for producing a braid that extends in a longitudinal direction, wherein multiple individual strands, in particular metal wires, are interwoven with one another about a longitudinal axis. The invention further relates to a braid of this type.

(Metal) braids of this type are used in particular as shields for electrical lines. The braid is generally attached directly to a line core that is to be shielded and the line core forms in this manner a center of the braid. So-called rapid braiding machines in particular are used for this purpose. The machines generally comprise two counter-rotating arrangements of spool carriers that each carry spools and the individual strands are drawn off from said spools. One of these arrangements of spool carriers performs a wave movement during the rotating process. The wave movement produces a circulatory path of the counter-rotating further arrangement of the spool carriers with the result that the individual strands that are running in opposite directions and the wire bundle are interwoven as desired.

In order to achieve a high as possible process speed when producing the braid, it is necessary—depending upon how thick the braid is to be—for the arrangement of the spool carriers to operate at a very high rotational speed. The rotational speed is by way of example more than 100 rotations per minute and frequently by way of example 175 rotations per minute. In particular in the arrangement of spool carriers that perform the wave movement, this means that—by by way of example where four waves per rotation are performed—a respective spool must change direction more than 20 times per second. Thus, extremely high centrifugal forces are produced. In order to be able to absorb the mechanical forces that occur, the mass of a respective spool is therefore limited. This fill quantity of a respective spool is currently typically a maximum of approximately 2 kg.

In the case of typical braids that are formed by way of example from a total of 16 individual strands, a fill quantity of this type means that only lengths of approximately 4 km are possible in a continuous process. It is subsequently necessary to replace the empty spools with full spools. This therefore requires that the device, also referred to as a braiding machine, is retooled which in turn is associated with a not insignificant outlay with respect to time.

### SUMMARY OF THE INVENTION

It follows from this that the object of the invention is to render it possible to produce a braid as quickly as possible in particular with short retooling times.

The object is achieved in accordance with the invention by a method for producing a braid that extends in a longitudinal direction, wherein multiple individual strands are interwoven with one another about a center, in particular about the longitudinal axis. For this purpose, multiple spools on to which individual strands are wound are moved relative to one another in a defined manner so as to form the braid. The individual strands are simultaneously drawn off in the longitudinal direction so as to form the braid. In order to render it possible to perform the production process as quickly as possible with short retooling times, a part of these spools, namely the first spools, on to which first individual strands are wound, are guided on a circulatory path about the longitudinal axis, in particular a circular path. In general, these first spools are moved on the circulatory path in a direction of rotation without changing directions of curve. Fundamentally, this circulatory path may therefore also be configured in an elliptical manner. However, it is preferred that the path is configured as a circular path. The first individual strands are placed in a helical manner at least in sections about the longitudinal axis, in other words in the finished braid they extend in a helical manner at least in sections about the longitudinal axis. A further part of the spools, namely the second spools, that are provided with second individual strands, are arranged in contrast with respect to the direction of rotation at fixed angle positions. In other words, insofar as with respect to the circulatory movement of the first spool, they are arranged in a steady-state. The second individual strands that are unwound from these second spools extend parallel to the longitudinal direction as a result of the fixed angular arrangement.

This embodiment provides the particular advantage that it is not necessary for the second spools to perform a wave movement and on the contrary said second spools are arranged in a fixed manner. The centrifugal forces that are acting on the first spools are—as a result of the in particular circular path—lower that when a wave-shaped rotational movement is being performed. Overall, it is consequently possible to increase the weight of the spools in comparison to conventional spools with the result that retooling is required less frequently and thereby retooling times are reduced overall.

In order to realize the desired interwoven arrangement between the individual strands or bundles of strands, it is provided in the expedient embodiment that the second individual strands—when viewed in the longitudinal direction—are fed in in an alternating manner below and above the first individual strands. As a consequence, the first or second individual strands are therefore configured in an alternating manner as a lower layer or an upper layer of the braid. Typically, in the case of braids of this type generally a multiplicity of first individual wires are guided adjacent to one another together as a bundle in an alternating manner as a lower layer and an upper layer.

In order to feed in the second individual strands in an alternating manner once below and above the first individual strands, the respective second individual strands are guided via guiding elements that are moved in a perpendicular manner with respect to the direction of rotation and thus perpendicular to a path plane of the first spools. The guiding elements consequently deflect the second individual strands in the longitudinal direction or in the opposite direction thereto. It is therefore not necessary for the spools to move. Only a type of pendulum movement is performed with the aid of the guiding elements.

A respective guiding element contains at least one, preferably two, deflection rollers that aid the guidance of the second individual strands. Depending upon the actual direction of movement of the guiding elements, the respective individual strand is guided by one of the two deflection rollers. The deflection rollers are therefore spaced apart with respect to one another in particular in the longitudinal direction and their axes of rotation extend perpendicular to the longitudinal axis.

Thus, the second individual strands therefore each cross the path of the first individual strands in order to realize that the individual wires interweave with one another as desired.

In order to render it possible for the circulatory path of the first spools to be crossed by the second individual strands, it is fundamentally possible to arrange the first spools on a common rotating spool carrier and to guide the second individual wires by way of example within a central free space of the common spool carrier.

However, the first spools in a preferred embodiment are arranged individually or also in multiple groups on multiple spool carriers that may move along a mechanical path guide and are also moved during the operation along this mechanical path guide. The path guide may be by way of example a type of rail guide. The individual spool carriers are therefore automatically guided in particular in a mechanical manner. However, it is not compulsory to provide a mechanical automatic guide or a mechanical rail. A mechanical path guide does however ensure that the spool carriers are guided in a reliable manner.

In an expedient embodiment, the second spools are arranged outside the circulatory path of the first spools. They are therefore spaced further apart from the central longitudinal axis. In order to render it possible for the path of the first spools to be crossed by said second individual strands as desired despite the mechanical path guide, the mechanical path guide is configured in segments and comprises, in particular at the positions at which the second spools are arranged, interruptions in particular in the form of slits. Thus, it is rendered possible in a simple embodiment for the path of the first spools to be crossed. The second individual strands are for this purpose in each case merely repeatedly inserted from below or from above through the respective slits. This is performed in particular with the aid of the previously described guiding or deflecting elements.

In order to ensure that the spool carriers reliably bridge the slits, the spool carriers comprise a length that is greater than a width of the slits. The spool carriers are therefore still guided at each point in time as they cross the slits in a reliable manner by a section of the path guide.

In an expedient manner, the spool carriers are each driven individually and are therefore not connected to one another. They are merely arranged collectively on the path guide.

In an expedient manner, the spool carriers are driven in an electromagnetic manner. For this purpose, it is preferred that in each case magnets are arranged on the path guide and also on the spool carrier, wherein electromagnets are provided on the path guide and/or on the spool carrier and the electromagnets may be controlled during the operation in an appropriate manner so as to drive the spool carriers as desired in the circumferential direction. The electromagnets cooperate for this purpose with further magnets, in particular permanent magnets. In particular, permanent magnets are arranged distributed along the path guide.

In accordance with a preferred embodiment, the spool carriers are guided in a contactless-manner along the path guide with the result that they are therefore guided as a type of magnetic levitation train along the path guide in a floating manner without mechanical contact.

In general, a respective spool carrier together with the path guide forms a linear motor. It is provided in particular that a multiplicity of individual magnets in particular permanent magnets is arranged along the path guide and distributed around the entire circumference of the path guide. A respective spool carrier contains in particular at least one electromagnet that is controlled and the polarity reversed in an appropriate manner so as to realize the desired drive.

It is preferred that the number of second spools is greater than the number of first spools, by way of example by (at least) the factor 1.5 or (at least) the factor 2. Thus, the retooling times are further reduced. The reason for this is that the second spools require replacing less frequently.

In an expedient manner, the second spools are larger and/or heavier than the first spools. The second individual strands are in particular considerably longer than the first individual strands, in each case in the original state in the case of new spools. Thus, the second spools require replacing less frequently in comparison to the first spools.

In addition, the embodiment that contains in particular spool carriers that may be driven individually also renders it possible to create new braid patterns. For this purpose, it is provided in a preferred further development that the first spools perform a pendulum movement. The term ‘pendulum movement’ is understood to mean that the direction of rotation is in particular also repeatedly changed. This results overall in the fact that the first individual strands form a helical line that extends only in part about the longitudinal axis, in other words it is not closed in a circumferential manner. On the contrary, as a consequence, the direction of rotation of the first individual strands is periodically repeatedly changed.

In one expedient embodiment, it is realized as a result that openings that extend in particular in the longitudinal direction are provided in the braid, the openings being by way of example slits or at least regions of the individual strands that are covered to a lesser degree. Thus, a slit-type opening is intentionally provided within the braid with the result that in particular with respect to a desired electrical shielding effect this is at least reduced in the region of this opening. As a consequence, it is rendered possible to adjust the electrical characteristics of the braid in a purposeful manner such that it is possible for electromagnetic waves to enter or exit by way of example in this region of the slit-shaped openings. This is important by way of example when designing and producing antennae with the result that electromagnetic waves may be radiated as desired into or out of the center that is surrounded by the braid.

In accordance with a further preferred embodiment variant, third individual strands are provided wound around a part of the individual strands of the second group. Therefore, a bundle is formed in this manner within the braid and the bundle contains a plurality of first or also of second individual strands that are surrounded by the third individual strands. Thus, a bundle wire is formed in this manner within the braid and the bundle wire is interwoven into the braid.

It is frequently necessary particularly in the case of electrical shielding arrangements that these shielding arrangements are contacted in an electrical manner at the end by way of example in the region of a plug connector. This is frequently associated with a high outlay. In some instances, so-called drain wires are inserted so as to make electrical contact with the shielding arrangements. A bundle of this type that is integrated in the braid renders it possible in a particularly simple manner to produce an electrical contact with the shielded braid. For this purpose, it is only necessary to make electrical contact with this wire bundle.

In a preferred embodiment, in order to provide this wire bundle, three spools having third individual strands are provided, wherein these third spools are guided on a further circulatory path that does not however circulate the longitudinal axis. As a result, it is rendered possible that the third individual strands are not wound around a part of the second individual strands during the production process of the braid.

Furthermore, the object is achieved in accordance with the invention by a braid that contains a plurality of individual strands that are interwoven with one another, extends in the longitudinal direction and is formed about a longitudinal axis. A part of the individual strands, namely first individual strands, extend in a helical manner at least in part about the longitudinal axis in a direction of rotation. A further part of the individual strands, namely second individual strands, extend parallel to the longitudinal direction.

It is preferred that the first individual strands extend entirely in a helical manner about the longitudinal direction.

As an alternative thereto, the first individual strands repeatedly change their direction of rotation with the result that they do not completely extend in a helical manner about the longitudinal axis.

It is preferred that third individual strands are wound around a part of the individual strands in particular so as to form a wire bundle that is woven into the braid as a braid strand.

Finally, the object is further achieved in accordance with the invention by a device for producing a braid that extends in the longitudinal direction and contains individual strands. The device contains spools and the individual strands are wound onto the spools. These spools are first spools having first individual strands and second spools having second individual strands. The first spools may move during the operation on a circulator path, in particular a circular path, about the longitudinal axis, in a direction of rotation with changing the direction of curve and are also moved along the circulatory path during the operation. In addition, the second spools are arranged at fixed angular positions during the operation.

Other features which are considered as characteristic for the invention are set forth in the appended claims.

Although the invention is illustrated and described herein as embodied in a method and a device for producing a braid and a braid, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, to plan view of a device for producing a braid according to the invention;

FIG. 2 is a lateral view of the device;

FIG. 3 is a sectional lateral view of the braid in accordance with a first embodiment variant;

FIG. 4 is a sectional lateral view of the braid in accordance with a second embodiment variant; and

FIG. 5 is a sectional lateral view of the braid in accordance with a third embodiment variant.

### DETAILED DESCRIPTION OF THE INVENTION

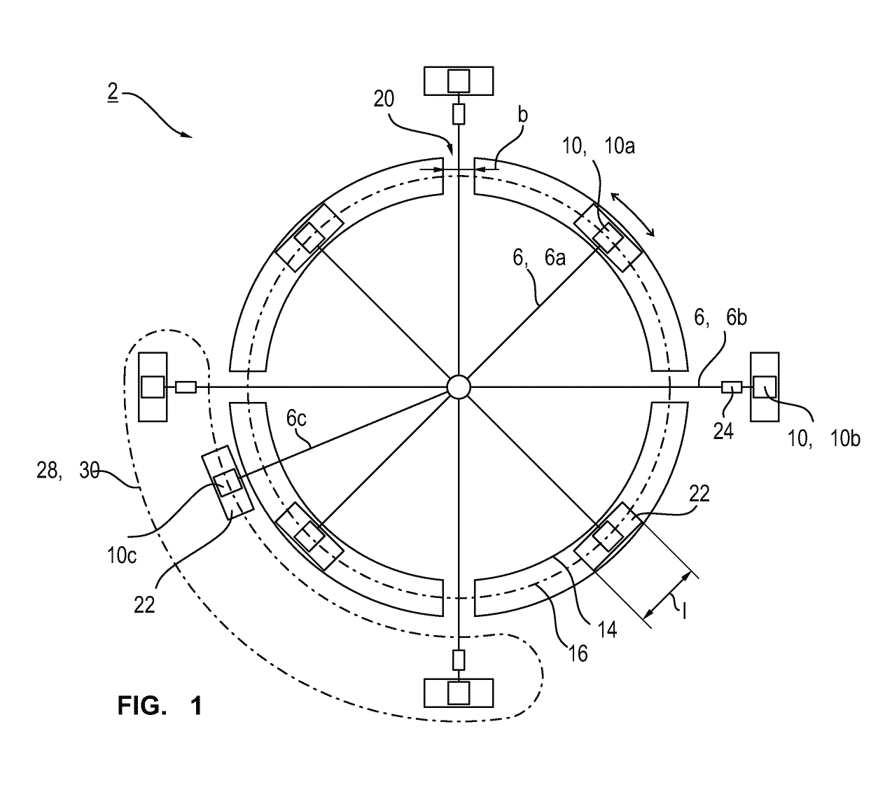

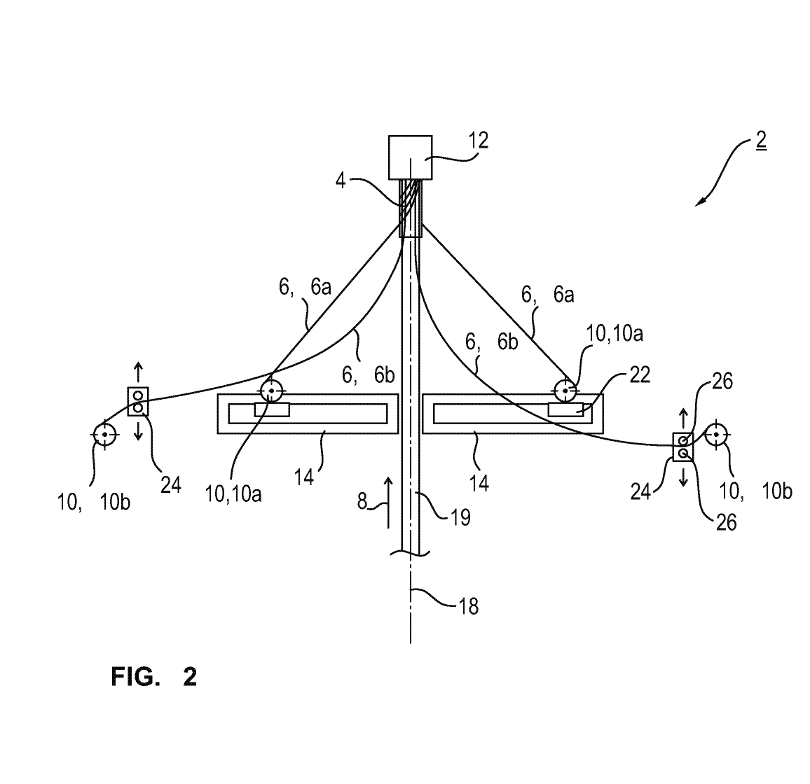

Referring now to the figures of the drawings in detail and first, particularly to FIGS. 1 and 2 thereof, there is shown a device 2 and also a method for producing a braid 4. The braid 4 is in particular a metal braid contains a multiplicity of individual strands 6 that are interwoven with one another and are formed in particular by individual wires. The braid 4 is overall a tubular structure that extends in a longitudinal direction 8. The braid 4 is in particular pulled on as a shielding braid for shielding electrical lines. Depending upon the line, the braid 4 has typically a diameter in the range of a few millimeters up to by way of example 10 mm. Fundamentally, shielding braids are also possible that have a larger diameter for correspondingly thicker lines or cables, by way of example braids 4 with a diameter of up to 20 mm, up to 30 mm or even more. Braids 4 of this type contain typically 8, 16, 24 or 32 individual wires.

In order to produce braids 4 of this type, individual strands 6 are interwoven with one another. For this purpose, the individual strands 6 are initially unwound from spools 10 and guided toward a drawing-off device 12 which is used to draw off the braid 4 that is being formed in the longitudinal direction 8 in particular upward. The longitudinal direction 8 defines therefore simultaneously a drawing-off direction.

In general, the individual strands 6 are frequently guided in groups and the groups of individual strands 6 are guided by virtue of suitably guiding the spools 10 repeatedly above and below the individual strands 6 of the other group with the result that the desired interwoven structure is produced.

The device 2 contains a first group of first spools 10a and the first individual strands 6a are wound in this case onto the first spools. These first spools 10a are guided on a mechanical path guide 14, in particular a type of rail guide, on a preferably circular path 16 that circulates around a center that is formed by a longitudinal axis 18. During the production of a shielded line, the center is formed by means of a line core and the braid 4 is attached around the line core. In general, the braid 4 is attached to a central strand 19. The central strand 19 and consequently the line core are by way of example parts of a coaxial cable and the braid 4 forms an outer conductor of the coaxial cable. Alternatively, the line core is formed by a number of core pairs that are by way of example twisted with one another or also are not twisted. The lines are typically data lines, wherein the lines are not limited thereto.

Second spools 10b are provided in addition to the first spools 10a and the second spools are arranged fixed in place at fixed angular positions. Second individual strands 6b are unwound from these second spools 10b. The second spools 10b are arranged outside the circular path 16 and consequently outside the mechanical path guide 14.

The mechanical path guide 14 is interrupted at the respective positions of the second spools 10b and contains slits 20 by means of which the second individual strands 6b are each guided in the direction toward the longitudinal axis 18. The mechanical path guide 14 is therefore formed in other words overall as a segmented path guide 14 and contains multiple circular arc segments.

In the exemplary embodiment, four second spools 10b are provided and accordingly four slits 20. It is preferred that the second spools 10b are arranged generally distributed uniformly around the circumference of the path 16, in the exemplary embodiment in FIG. 1 therefore with a fixed angular spacing of 90 degrees.

The number of first spools 10a corresponds by way of example to the number of second spools 10b. Alternatively, more second spools 10b are provided and/or these are of a larger size and provided with more wire material. As previously mentioned, braids are usually produced with 8, 16, 24 or 32 individual strands 6. Typically, a corresponding number of spools 10 are also provided.

The first spools 10a are arranged on spool carriers 22. The spool carriers 22 are arranged so as to be able to move along the path guide 14. The spool carriers 22 are able to move individually, therefore fundamentally independently of one another, in other words each spool carrier 22 contains preferably a dedicated drive unit. The drive force is produced in particular in an electromagnetic manner. It is preferred that the spool carriers 22 form together with the path guide 14 a type of linear motor. For this purpose, a multiplicity of permanent magnets are arranged around the path 16 on the mechanical path guide 14 in a manner not illustrated here. In a complementary manner thereto, the spool carriers 22 each comprise at least one electromagnet that is controlled accordingly for the forward drive in a desired direction.

The individual spool carriers 22 and the first spools 10a are each typically driven at the same rotational speed and in the same direction.

The spool carriers 22 may in principle move in two directions of rotation, as indicated by the arrows.

A respective spool carrier 22 contains a length l that is greater than a width b of the slits 20. A respective spool carrier 22 bridges a respective slit 20 as a result of the greater length l. In particular, the length l is preferably at least twice as large as the width b. As a consequence, a respective spool carrier 22 is also guided in a reliable manner when the slits 20 are bridged.

In addition, a guiding element 24 is also allocated to the second spools 10b respectively and the guiding element is used to guide the second individual strands 6b respectively in a radial direction toward the longitudinal axis 18. The guiding elements 24 are able to move in the longitudinal direction 8 or in the opposite direction thereto. With the aid of the guiding elements 24, the second individual strands 6b are “raised” or “pushed downward”, with the result that the second individual strands are guided in an alternating manner—when viewed in the longitudinal direction 8—once above and once below the first individual strands 6a.

The guiding elements 24 preferably comprise two deflecting elements, in particular deflecting rollers 26, and the respective second individual strand 6b is guided between the deflecting elements.

In order to produce the braid 4, the spool carriers 22 and at the same time the first spools 10a are guided in a predetermined direction of rotation on the path guide 14 at a predetermined speed. The first individual strands 6a are drawn off simultaneously. In parallel thereto, the second individual strands 6b are drawn off upward in the longitudinal direction 8 by the drawing-off device 12.

It is of considerable importance that the second spools 10b are arranged in a fixed manner at the fixed angular positions. In this respect, the second spools 10b do not experience any centrifugal forces as a result of a rotation about the longitudinal axis 18, as would be the case in conventional braiding machines.

Furthermore, in order to form the interwoven structure, it is provided that the guiding elements 24 repeatedly perform a pendulum motion in the longitudinal direction 8 or in the opposite direction thereto with the result that the second individual strands 6b are guided in an alternating manner once below and once above the first individual strands 6a with the result that when the braid 4 is finished said strands form once a lower layer and once an upper layer of the braid.

FIG. 1 illustrates an additional variant. In actual fact, in an alternative embodiment, a further mechanical path guide 28 is provided in addition and a further circulatory path 30 is formed that is arranged in a circulatory manner around a multiplicity of the second spools 10b. The additional path 30 is however not configured so as to circulate with respect to the longitudinal axis 18 or the center. At least one third spool 10c is guided in a circulatory manner on the further path guide 28 and a third individual strand 6c is uncoiled from said third spool and is drawn off from the drawing-off device 12 so as to be configured and braided into the braid 4. Fundamentally, it is also possible to arrange multiple third spools 10c on multiple spool carriers 22 on the additional path 28. The third individual strand 6c is therefore wound around the second individual strands 6b of the respective second spool 10b that are surrounded by the additional path 30 with the result that a wire bundle 32 around which individual strands 6c are wound (see in this respect in particular FIG. 4) is formed in this manner in the braid 4.

As a result of the individual spool carriers 22 being driven in an electromagnetic manner, the spool carriers, as already mentioned, are able to move in both directions. It is therefore rendered possible in particular during the braiding process to also reverse the direction of movement.

In accordance with a preferred embodiment, it is furthermore provided that the spool carriers 22 do not move in a completely circulatory manner about the longitudinal axis 18 but rather in each case reverses the direction of movement prior to achieving a complete rotation. Thus, it is possible to form a variable braided pattern, by way of example also with openings 34 in the braid 4, such as is illustrated for example in FIG. 5. The term “opening 30” is understood in general to mean a region of the braid 4 that comprises at least a degree of covering that is smaller in comparison to adjacent regions of the braid 4 in which in other words fewer individual wires 6 are provided.

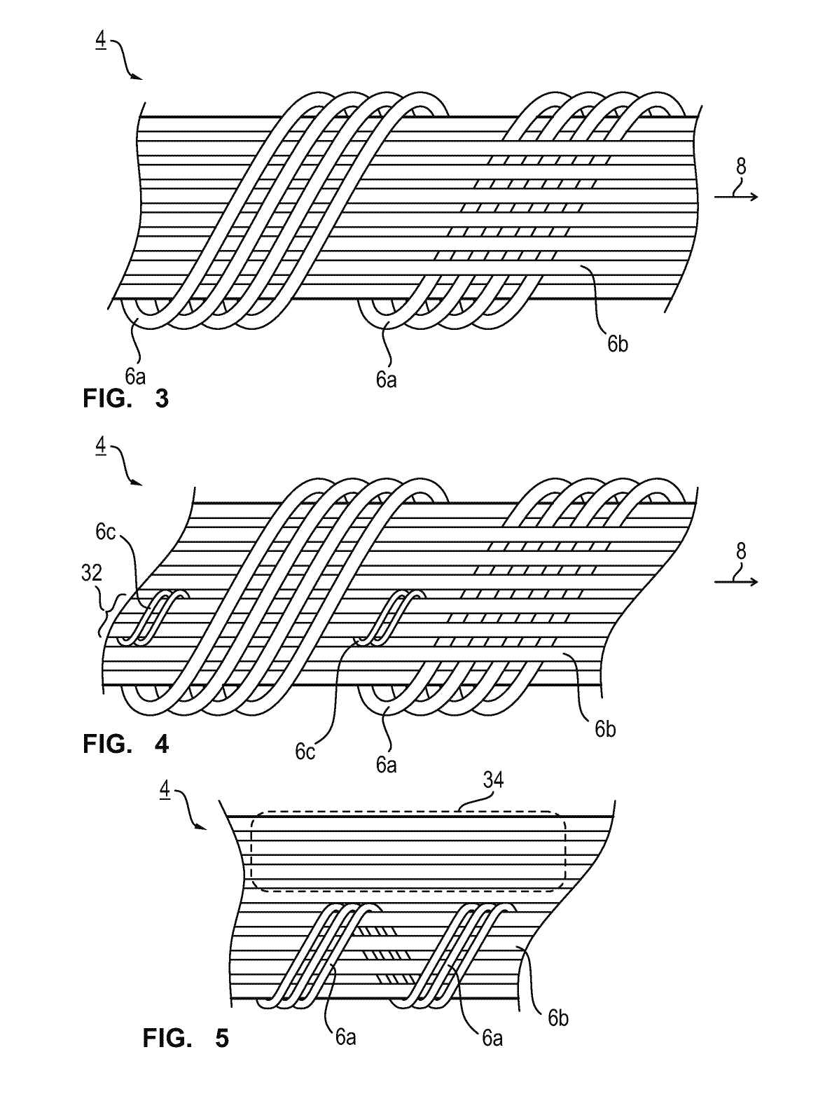

The different variants of the braid 4 are in general illustrated schematically in FIGS. 3 to 5. The basic variant and basic design of the braid 4 is illustrated in FIG. 3. It is apparent in the figures that the braid 4 extends overall in the longitudinal direction 8. The second individual strands 6b extend parallel to the longitudinal direction 8. This is as a result of the fact that the second spools 10b are fixed in position and that during the production process the second individual strands 6b are interwoven in a parallel manner with respect to the longitudinal axis 18 into the braid that is being formed. The second individual strands 6b are arranged in particular at an equal spacing with respect to one another.

The second individual strands 6a are arranged in a helical manner about the longitudinal axis 18 or about a center. This is a result of the circulatory movement of the second spools 10a with the superimposition of the drawing-off movement in the longitudinal direction 8. Since the second individual strands 6b are guided in an alternating manner above or below the first individual strands 6a, the first individual strands 6a (and also correspondingly the second individual strands 6b) form in an alternating manner an upper or lower layer. The first individual strands 6a, there being a total of 4 in the exemplary embodiment, are each guided as a group with the result that as a group they each form an upper or lower layer.

FIG. 4 illustrates a braid 4 that starting from the basic braid, as illustrated in FIG. 3, is also provided with the already mentioned wire bundle 32. For this purpose, a part of the second individual strands 6b are surrounded by the at least one third individual strand 6c with the result that a multiplicity of the second individual strands 6b is surrounded by the third individual strand 6c. A wire bundle 28 of this type is preferably connected to a contact element or a ground connection during the production process with the result that the braid 4 is therefore contacted in an electrical manner and in particular is connected to ground.

Finally, FIG. 5 illustrates a further embodiment variant in which preferably in turn starting from the basic braid illustrated in FIG. 3 at least one opening 34 is worked into the braid 4. This is achieved by virtue of the fact that the first individual strand 6a is not completely guided in a circulatory manner about the longitudinal axis 18 or the center. Openings 34 of this type, in other words at least regions that are covered to a lesser degree, are by way of example used so as to define in a purposeful manner regions which may emit or receive electromagnetic waves. For this purpose, a transmitter antenna or also a reception antenna is configured or arranged by way of example in the interior.

1. A method for producing a braid that extends in a longitudinal direction, which comprises the steps of:
interweaving a plurality of individual strands with one another about a longitudinal axis, the interweaving comprises the following sub-steps of:
moving a plurality of spools on to which the individual strands are wound relative to one another in a defined manner to form the braid and the individual strands are drawn off in the longitudinal direction so as to form the braid, the plurality of spools include first spools and second spools and the individual strands include first individual strands and second individual strands;
guiding the first spools having the first individual strands on a path that circulates about the longitudinal axis in a direction of rotation with a result that the first individual strands are placed in a helical manner at least in sections about the longitudinal axis; and
disposing the second spools having the second individual strands with respect to the direction of rotation at fixed angular positions with a result that the second individual strands are incorporated into the braid in a manner in which they extend parallel to the longitudinal direction.

2. The method according to claim 1, which further comprises guiding the second individual strands, with respect to the longitudinal direction, in an alternating manner below and above the first individual strands.

3. The method according to claim 2, which further comprises guiding the second individual strands by use of guiding elements that are moved in a perpendicular manner with respect to the direction of rotation with a result that the second individual strands are guided in an alternating manner below and above the first individual strands.

4. The method according to claim 1, which further comprises disposing the first spools on spool carriers that are moved along a mechanical path guide.

5. The method according to claim 4, which further comprises disposing the second spools outside a circulatory path and the mechanical path guide is segmented and is interrupted by slits at angular positions of the second spools.

6. The method according to claim 5, which further comprises configuring the spool carriers to be longer than a width of the slits so as to bridge the slits.

7. The method according to claim 4, which further comprises driving the spool carriers individually.

8. The method according to claim 4, which further comprises driving the spool carriers in an electromagnetic manner.

9. The method according to claim 8, wherein a respective spool carrier together with the mechanical forms a linear motor.

10. The method according to claim 1, wherein a number of the second spools is greater than a number of the first spools.

11. The method according to claim 1, wherein the first spools perform a pendulum movement in such a manner that a helical line is not connected in a circulatory manner.

12. The method according to claim 1, which further comprises configuring the braid with openings or regions that are covered to a lesser degree.

13. The method according to claim 1, which further comprises providing at least one third spool together with third individual strands, the third individual stands are guided on a further circulatory path that does not circulate the longitudinal axis.

14. The method according to claim 13, which further comprises winding the third individual strands around a part of the second individual strands.

15. A braid, comprising:
a plurality of individual strands that are interwoven with one another and extend in a longitudinal direction and disposed around a longitudinal axis, wherein a part of the individual strands, namely first individual strands, extend in a helical manner at least in part about the longitudinal axis in a direction of rotation and a further part of the individual strands, namely second individual strands, extend parallel to the longitudinal direction.

16. The braid according to claim 15, wherein the first individual strands change their direction of rotation repeatedly.

17. The braid according to claim 15, which further comprises winding third individual strands around a part of the second individual strands.

18. A device for producing a braid that extends in a longitudinal direction, the device comprising:
spools; and
individual strands, including first individual strands and second individual strands, wound onto said spools, said spools including first spools having said first individual strands and second spools having said second individual strands, wherein said first spools may move during an operation on a path that circulates about the longitudinal direction in a direction of rotation and said second spools are disposed at fixed angular positions during the operation.
